(19) United States
(12) Patent Application Publication
(10) Pub. No.: US 2022/0051556 A1
(43) Pub. Date: Feb. 17, 2022

(54) UNIVERSAL WIRELESS CONTROL DEVICE

(71) Applicant: Konstantin BORISOV, Odessa (UA)

(72) Inventor: Konstantin BORISOV, Odessa (UA)

(21) Appl. No.: 17/594,613

(22) PCT Filed: Apr. 27, 2020
(86) PCT No.: PCT/IB2020/053934

§ 371 Date: Oct. 25, 2021

(30) Foreign Application Priority Data
Apr. 25, 2019 (UA) U201904536

(51) Int. Cl. G08C 17/02; G06F 3/0338; G06F 3/038; G08G 5/00

(52) U.S. Cl. CPC G08C 17/02; G08G 5/0069; G06F 3/0383; G06F 3/0338

(57) ABSTRACT

A universal wireless control device containing a handle body, sensors for measuring the position of the body, a units for moving, control buttons, a signal processing unit, a power source, a communication channel with a controlled device, characterized in that the signal processing unit and the power source are located in the handle body of the control device, and the handle body itself has an ergonomic shape, adapted to be covered by the hand, and the units are located in blind reach, and the position sensors of the units for moving of the control device the sensors forms the control axes by manipulation of units for moving or the position of handle body.

### FIELD OF THE INVENTION

The declared invention relates to the field of electronics and instrumentation, namely to means of remote control of other devices with the ability to move them with several levels of freedom, and can be used to control an unmanned aerial vehicle, model aircraft, personal computer, be used on the basis of gaming platforms and with others electronic devices where the user needs to send navigation signals.

### BACKGROUND OF THE INVENTION

Many different types of control devices have been created for different purposes. The most common control device is the so-called “mouse”, which outputs positioning variables in two dimensions for use in controlling applications in a computer.

Other control devices are also known, which include a so-called joystick, which outputs the positioning variables of the housing handle also in two dimensions. However, by using additional buttons in combination with the casing handle, the number of positioning levels can be increased. However, it should be understood that such a device only physically measures positioning in two dimensions.

A trackball is also known, which also provides data for two measurements.

A game pad often uses a small, joystick-like handle to measure positioning variables, and which can expand the controller's range of functionality to manipulate large amounts of data using additional buttons.

A rudder-like control device is also known which provides data in only one dimension.

In many of the solutions developed, the control device performs only an approximate analysis and does not perform absolute measurements, which means that in order for the software based on the absolute coordinates of the control device to work correctly, it is necessary to carry out complex calculations in order to continuously monitor the state of the control device. Such devices require regular calibration, otherwise they constantly accumulate errors that can quickly become critical, depending on the software.

For industrial or professional applications, two levels of measurement are often not enough and there is a need to measure and analyze more physical positioning variables. For this purpose, several solutions can be found in the patent literature, for example, the solution according to the patent WO 8805942, which shows a joystick device that has six levels of freedom, in U.S. Pat. No. 5,854,622, which shows a joystick for measuring motion along six levels of freedom, or in U.S. Pat. No. 5,565,891, where it is shown hand controller with six levels of freedom.

However, these solutions are difficult to use and expensive to manufacture, and/or they can be difficult to implement in some application areas, depending on their geometrical dimensions and design.

All of the above solutions are designed for a manual control device to control some external processes, for example, in a computer game or to control equipment, vehicles or other machines.

Also known and widely used is a method of entering information into a computer using a keyboard and a joystick, in which a display and a control unit are involved. By pressing the keys on the keyboard or joystick, the operator initiates the transmission of the corresponding electronic codes to the control unit. Receiving electronic codes, the control unit generates the appropriate control commands

Also known is the patent U.S. Pat. No. 7,379,052 “Manual computer control devices”, according to which the device is attached to the hand by a belt or in other ways, and the control element of the device can be a trackball, joystick, touch panel or other device that can be controlled by the user's thumb separately or in combination with one or more switches that are pressed with your fingertips and provide functional equivalence to a standard computer mouse or trackball.

The disadvantages of this analogue is the functional unevenness of the load on the fingers. Almost all functions are performed by the thumb, while the rest of the fingers are inactive. This reduces the efficiency and speed of control.

An analogue of the claimed solution is the patent of the Russian Federation No. 2333527 “Device for inputting information into a computer—anti-overload polyjoystick”.

According to patent No. 2333527, the device contains an outer shell that encloses the hand. Inside the shell there is an inner shell shaped like a hand, and between the shells, on the contrary, the surfaces of the phalanges of the fingers are located sensitive elements. On the lower inner surface of the outer shell opposite the lower surfaces of the end phalanges of the fingers of the hand, there are control sensors connected by their sensitive elements in these places with the elastic inner shell of the device. Two-axis or One-axis joysticks, or buttons, or various combinations of various joysticks and buttons are used as control sensors.

In an analogue, the outer shell is fixedly connected either by a strong element of the body, in which information is entered into a computer, for example, a vehicle or other controlled object, or with a gyro-stabilized surface in the zone of convenient reach of the operator.

The disadvantage of the analogue is a high level of signal transmission interference and inconvenience of use, since the hands quickly get tired, constantly being in the position shown in the figures to the description of the patent.

The closest analogue (prototype) was the FT Aviator manipulator from Fluidity Tech (patent U.S. Pat. No. 10,198,086). So, in most cases, several controllers are usually used so that the user can control a control object that has more than three levels of freedom. In addition, any conventional control system that controls an object with six levels of freedom requires multiple controllers. For example, a set of independent controllers or input devices (e.g., joysticks, control columns, cyclic joysticks, foot pedals, and/or other independent controllers that may be known to one or more of those skilled in the art) can be used to convey many different rotation parameters (for example, pitch, yaw and roll) from the user to the controlled object (for example, an aircraft, underwater vehicles, spacecraft, control object in a virtual environment, etc.). Likewise, a set of independent controllers can be provided to control other navigation parameters such as movement (eg, movement along the x, y, and z axes) in three-dimensional (3D) space, speed, acceleration, and/or a variety of other command parameters.

The closest analogue describes several embodiments of a control system that allows the user to control an object up to six levels of freedom simultaneously and independently using one controller. In the first embodiment, the prototype may include one control for receiving and transmitting rotational movements (for example, pitch, yaw, and roll), and another control for receiving and transmitting translational movements (for example, displacement along X, Y, and Z). Both elements are housed in a combined hand controller for one user's hand.

The disadvantage of this closest analogue is that the use of the second hand in the prototype is still necessary, since some of the control buttons are located in the stand (second control element) of the controller, where the fingers of the hand holding the handle of the first control element do not reach, and the second hand is also needed for emphasis.

A distinctive feature of the claimed invention from the closest analogue is the absence of the need for constant use of the second hand to control the object in reality or in the game process.

Also, the claimed invention differs from the closest analogue by its small dimensions, lighter weight and the absence of separate body parts that are used for control.

### DISCLOSURE OF THE INVENTION

The objective of the claimed invention is to create a compact and ergonomic independent control device that allows remote control of third-party objects, in particular unmanned aerial vehicles, to measure variable hand positions in several (up to 9) levels of freedom and with the ability to provide additional data for control, using in combination with the positioning levels, separate control buttons, as well as provide the user with the ability to operate with one hand, while maintaining the possibility of long-term input of information without hand fatigue, which eliminates the formation of physical injuries and diseases of the user's hand.

To solve this problem, a universal wireless control device is claimed, comprising a handle body, sensors for measuring the position of the body, a units for moving, control buttons, a signal processing unit, a power source, a communication channel with a controlled device, characterized in that the signal processing unit and the source power supplies are located in the handle body of the control device, and the handle body itself has an ergonomic shape adapted to be covered by the hand, and the units for moving 1-3 are located in blind reach under the thumb and forefinger, while the units for moving 1 and 2 are located in mutually opposite sides with a displacement of the central axes from 0 to 20 degrees, and the control buttons are located under the units for moving 1 and 2, as well as under the other fingers of the hand and on the side opposite to the fingers, and the position sensors of the units for moving and moving the body form control axes by manipulating the device by means of movement or by the position of the handle body.

In this case, the distance between the end points of the central axes of the units for moving 1 and 3 is from 15 to 70 mm, and the distance from the end point of the central axis of the unit for moving 1 to the buttons under the fingers is 25 to 85 mm, and the distance from the end points of the central the axis of the displacement units 1 and 2 is 40 to 70 mm

Additionally, a gyroscope, accelerometer, compass, magnetometer or sensor combining all of the above are used as sensors for measuring the position of the handle body.

Additionally, touch buttons can be used as control buttons, as well as buttons protruding from the body by up to 2.5 mm

Additionally, the control buttons can have latching multi-position switches.

The functions of the control buttons are set by the operator programmatically and/or with the help of an additional control button located under the thumb, allows you to assign a new value to other buttons.

Additionally, the communication channel with the controlled device can be an interface of the state of the control device and connections with other devices.

Additionally, the control device is equipped with a connector for contacting third-party electronic devices.

When designing the claimed invention, the principle of maximizing the flow of information from the user to the controlled device through the control device was applied. Therefore, through the design, it takes no more than 0.25 seconds to enter each command or use devices to move.

Through the the oppositely placed two devices for moving under the thumb and forefinger, as well as the location of the third device for moving and buttons in the zone of quick “blind” (does not require visual control) access, the availability of all functionality of two-handed joysticks and control panels in one hand is achieved.

The communication channel with the controlled device can have a communication interface for communication with external devices or additional devices attached to the device. Such additional devices may include, among others, a smartphone, tablet, force feedback device, jigs, or similar devices for interacting with a user of the control device.

The interface for communicating with external devices or internal sensor inputs can be implemented using any suitable connector or connectors that are known to those skilled in the art, including but not limited to USB (Universal Serial Bus), Firewire, RS232, RS485, Ethernet, parallel Centronics port, GPIB (universal interface bus), various wireless interfaces (such as Bluetooth and WLAN), etc. All of the listed interfaces correspond to existing standard interfaces, however, it should be understood that interfaces for the claimed invention may be created according to standards that will appear in the future, or even be non-standard interfaces.

### BRIEF DESCRIPTION OF THE DRAWINGS

FIG. 1 illustrates a one side view of the control device.

FIG. 2 illustrates a view from the other side of the control device

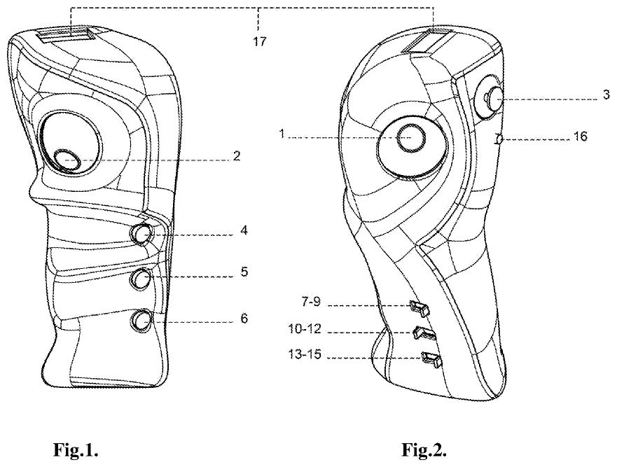

### DETAILED DESCRIPTION

The universal wireless control device includes units for movement similar to analog sticks (1-3), which are located so that they are within 0.25 second blind reach under the thumb and forefinger.

The movement device (analog stick) 3 is located away from the other movement device 1 and is controlled by the thumb.

Devices for movement 1 and 2 are located in mutually opposite directions with a shift of their central axes from 0 to 20 degrees.

The control device determines its position in space by forming two virtual axes, which are controlled by deviating the position of the handle body from the central axis using a 9-axis gyroscope-accelerometer-compass sensors.

The sensors are located inside the case and are activated either by pressing a button defined in the settings, or when the device is turned on (defined by the user). The central axis of the virtual axes is set when the virtual axes are activated.

A biaxial position sensor la with a movement device 1 is located on the rear side of the control device and is located directly under the user's thumb. To the right of it there is a biaxial sensor 3a connected with a device for moving 3 reduced dimensions to control minor functions or to program them for a push-button mode of operation.

A biaxial sensor 2a , connected to the movement device 2, located under the index finger and opposed towards the sensor la in such a way that during use not only perform data input, but also act as an additional point of holding the control device in the hand.

The control device also has 15 control buttons that give out functional signals:
6 buttons without locking, 2 of which are located under the devices for movement (1,2).
3 buttons (4-6) are located under the tips of the middle, ring and pinky fingers in the finger grooves that send the corresponding command signal only when pressed.
3 three-position switches (7-15) with latching are located to the right of the device for moving 2 and buttons 4-6.

Each individual switch position will activate a specific number button permanently until the switch is moved to a different position.

A group of three-position switches is recommended for assigning functions, the accidental activation of which may negatively affect the overall control process or may pose a danger to the controlled device or to people.

Below the device for moving 3 at a distance of one phalanx of the thumb is a button 16, by pressing which you can assign another value to any other button on the control device.

This button is designed to be pressed by the phalanx of the thumb.
17—joystick status monitor and/or connector for connection to other devices.

The declared invention, when connected via a wireless interface module to a computer, is defined as a game controller or as a virtual port for connecting telemetry.

The claimed invention can be used in games or other software products as a game manipulator, and through the customizer program, you can set the values of buttons and devices for movement, disable or reassign axes, buttons and their functions. If necessary, the radio module is configured through the customizer program as an additional device for the claimed invention.

The claimed invention can be used in computer games, in driving vehicles, as well as for simulators. Simulators are used in various fields, for example, for training pilots, machine tool operators, doctors, and the like.

In one embodiment, a plurality of universal wireless control devices are contemplated that are coupled to a single interface device (not shown), eg, two control devices, where one control device is used to control one process and another control device is used to control another process. For example, in gaming applications (computer games), one device can be used to control the movements of a character, and the second control device is used to control equipment, uses this character (for example, a car, etc.). Thus, the user can simultaneously control several functions or actions at the same time. This dual control device can be used to control other equipment that are known to those skilled in the art.

The claimed invention can be used in the operation, training and/or programming of robots. The operator can control the robot using the control device when operating the robot or when programming the robot to automatically perform tasks. A robot in this case can be a device used in automated production processes, for example on assembly lines in factories, etc.

It should be noted that the words “contains, including, adds up” does not exclude the presence of other elements or steps, in addition to those listed, and also does not exclude the presence of a plurality of such elements.

The above embodiments of the claimed invention are given for example only and do not limit the scope of legal protection. Specialists are aware of other solutions, applications, goals and functions that are included in the scope of legal protection of the claimed invention.

1. A universal wireless control device containing a handle body, sensors for measuring the position of the body, a units for moving, control buttons, a signal processing unit, a power source, a communication channel with a controlled device, characterized in that the signal processing unit and the power source are located in the handle body of the control device, and the handle body itself has an ergonomic shape, adapted to be covered by the hand, and the units for moving 1-3 are located in blind reach under the thumb and forefinger, while the units for moving 1 and 2 are located in mutually opposite the sides with displacement of the central axes from 0 to 20 degrees, and the control buttons are located under the units for moving 1 and 2, as well as under the other fingers of the hand and on the side opposite from the fingers, and the position sensors of the units for moving of the control device the sensors forms the control axes by manipulation of units for moving or the position of handle body.

2. The universal wireless control device according to claim 1, characterized in that the distance between the end points of the central axes of the units for moving 1 and 3 is from 15 to 70 mm,

3. The universal wireless control device according to claim 1, characterized in that the distance from the end point of the central axes of the units for moving 1 to the buttons under the fingers of the hand is 25 to 85 mm.

4. The universal wireless control device according to claim 1, characterized in that the distance from the end points of the central axes of the units for moving 1 and 2 is 40 to 70 mm.

5. A universal wireless control device according to claim 1, characterized in that a gyroscope, an accelerometer, a compass, and a magnetometer are used as sensors for measuring the position of the handle body.

6. A universal wireless control device according to claim 1, characterized in that a 9-axis sensor is used as sensors for measuring the position of the handle body.

7. Universal wireless control device according to claim 1, which differs in that touch buttons can be used as control buttons.

8. Universal wireless control device according to claim 1, which differs in that buttons protruding from the body by up to 2.5 mm can be used as control buttons.

9. A universal wireless control device according to claim 1, which is characterized in that the control buttons can have latching versatile switches.

10. The universal wireless control device according to claim 1, which differs in that the functions of the control buttons are set by the operator programmatically and/or with the help of an additional control button located under the thumb, allows you to assign other buttons a new meaning.

11. The universal wireless control device according to claim 1, characterized in that the communication channel with the controlled device can be an interface of the control device state and connection with other devices.

12. Universal wireless control device according to claim 1, characterized in that the control device is provided with a connector for contacting third-party electronic devices.
